(19) United States
(12) Patent Application Publication
(10) Pub. No.: US 2003/0039233 A1
(43) Pub. Date: Feb. 27, 2003

(54) Estimation of resources in cellular networks

(76) Inventors: Aharon Satt, Haifa (IL); Yoaz Daniel, Haifa (IL)

Correspondence Address: MERCHANT & GOULD P.C., P.O. Box 2903, Minneapolis, MN, 55402-0903, US

(21) Appl. No.: 09/929,828

(22) Filed: Aug. 14, 2001

(51) Int. Cl. H04Q 7/24

(52) U.S. Cl. 370/338; 370/389

(57) ABSTRACT

There are disclosed methods, systems, devices and articles of manufacture for processing measurements of resources, for example, bandwidth or bandwidth traffic, on the IP and cellular sides of data networks. Processing of these measurements is such that these resources, (e.g. bandwidth or bandwidth traffic), on the cellular side of the data network, can be managed (controlled) from the IP side of the data network.

### FIELD OF THE INVENTION

The present invention is directed to estimation of available resources in shared access media or cells within cellular networks, and management of packet based traffic through the cells.

### BACKGROUND

Cellular data networks including wired and wireless networks are currently widely and extensively used. Such networks include cellular mobile data networks, fixed wireless data networks, satellite networks, and networks formed from multiple connected local area networks (LANs). In each case, the cellular data networks include at least one shared media or cell.

FIG. 1 shows an exemplary data network 10, where a core cellular network 20 communicates with an Internet Protocol (IP) network 24 and cells 26, that provide services to subscribers 30, typically over channels 32. The IP network 24 connects with the core cellular network 20 over lines 34 or the like, and defines the “IP side” of the data network. The core cellular network 20 connects with cells 26 (although two are shown, this is exemplary only) over lines 36 or the like, and defines the “cellular side” of the network.

Presently, available bandwidth for transmissions through the cells 26 is limited technically, by physics, and legally, by regulations. The available (and hence the actual) rate for transmission of data to the subscribers over the cells is dynamically changing over time. A typical result of these limitations is congestion in the cells 26, leading to low quality of service (QOS) to the subscribers 30. Partial solutions for these problems have been proposed, but to date are substantially incomplete and have not been satisfactory.

One solution involves placement of a traffic shaper along the communication line 34 on the IP side of the network 10, between the IP network 24 and the core cellular network 20. This solution inefficiently manages bandwidth, for placing the traffic shaper on the IP side, fails to account for the actual bandwidth that should be managed at the cellular side, that can greatly differ from IP side.

Another proposed solution is managing bandwidth at the cellular side of the network 10, that involves placing a traffic shaper along the line 36, that connects the cells 26 and the core cellular network 20. This proposed solution is highly inefficient due to highly complex protocol structures on the cellular side, formed of numerous encapsulated protocol layers. Also, this protocol structure is not compatible with current IP based traffic shapers.

### SUMMARY

The present invention improves on the contemporary art by providing methods, systems, apparatus, and articles of manufacture (e.g., programmable storage devices, etc.), for processing measurements of resources, for example, bandwidth or bandwidth traffic, on the Internet Protocol (IP) and cellular sides of the data network, such that these resources, (e.g. bandwidth or bandwidth traffic), on the cellular side of the network, can be managed (controlled) from the IP side of the network. Processing typically involves correlating the measurements from both sides and estimating the cellular side resources in terms of IP side resources, allowing for monitoring and management (control) of the cellular side resources via IP-based devices, software, or the like, typically on the IP side of the network. The invention employs architectures that provide applications that are dynamic and can be performed “on the fly”.

An embodiment of the present invention is directed to a method for managing at least one resource, for example, bandwidth, in a data network, the data network including first and second sides in communication with each other, the first side including at least an Internet Protocol (IP) Network and the second side including at least one cell. The method includes, receiving data corresponding to at least one measurement of the at least one resource at each of the first and second sides, analyzing the data corresponding to the at least one measurement at each of the first and second sides; and controlling the at least one resource to the at least one cell, from the first side of said network.

Another embodiment of the invention is directed to a method for managing at least one resource, for example, bandwidth, in a data network, the data network including first and second sides in communication with each other, the first side including at least an Internet Protocol Network and the second side including at least one cell. The method includes obtaining at least one measurement of the at least one resource at each of the first and second sides, analyzing the at least one measurement from each of the first and second sides, and controlling the at least one resource to the at least one cell, from the first side of the network.

Another embodiment of the invention is directed to an apparatus, for example, a server, for managing at least one resource, for example, bandwidth, in a data network. The data network includes first and second sides in communication with each other, the first side including at least an Internet Protocol Network and the second side including at least one cell. The apparatus includes a storage device and a processor. The processor is programmed to receive data corresponding to at least one measurement of the at least one resource at each of the first and second sides, analyze the data corresponding to the at least one measurement at each of the first and second sides, and control the at least one resource to the at least one cell, from the first side of the data network.

Another embodiment of the invention is directed to a programmable storage device (program storage device, e.g., computer discs) readable by a machine, tangibly embodying a program of instructions executable by a machine to perform method steps for managing at least one resource in a data network, the data network including first and second sides in communication with each other. The first side includes at least an Internet Protocol Network and the second side includes at least one cell, the method steps selectively executed during the time when the program of instructions is executed on the machine (computer, workstation, etc.). The method steps include receiving data corresponding to at least one measurement of the at least one resource at each of the first and second sides, analyzing the data corresponding to the at least one measurement at each of the first and second sides, and controlling the at least one resource to the at least one cell, from the first side of the data network.

Another embodiment of the invention is directed to a method for estimating capacity of at least one cell. This method includes monitoring traffic associated with the at least one cell through at least one queuing device, the queuing device including a queue, obtaining at least one measurement of the output rate from the queue, obtaining at least one measurement of the amount of data in the queue, and determining at least one capacity estimation as an output rate from the queue, provided that the amount of data is within predetermined limits. The steps of obtaining at least one measurement of the output rate from the queue and obtaining at least one measurement of the amount of data in the queue, are typically performed contemporaneously and can be performed simultaneously.

Another embodiment of the invention is directed to an apparatus, for example, a server, for estimating capacity of at least one cell. The apparatus includes a storage device and a processor. The processor is programmed to: monitor traffic associated with the at least one cell through at least one queuing device, the queuing device including a queue; obtain at least one measurement of the output rate from the queue; obtain at least one measurement of the amount of data in the queue; and determine at least one capacity estimation as an output rate from the queue, provided that the amount of data is within predetermined limits. The processor is typically programmed to perform the steps of obtaining at least one measurement of the output rate from the queue and obtaining at least one measurement of the amount of data in the queue, contemporaneously, and can be programmed to perform these steps simultaneously.

Another embodiment of the invention is directed to a programmable storage device (program storage device, e.g., computer discs) readable by a machine, tangibly embodying a program of instructions executable by a machine to perform method steps for estimating capacity of at least one cell, the method steps selectively executed during the time when the program of instructions is executed on the machine (computer, workstation, etc.). The method steps including: monitoring traffic associated with the at least one cell through at least one queuing device, the queuing device including a queue, obtaining at least one measurement of the output rate from the queue; obtaining at least one measurement of the amount of data in the queue; and determining at least one capacity estimation as an output rate from the queue, provided that the amount of data is within predetermined limits.

### BRIEF DESCRIPTION OF THE DRAWINGS

Attention is now directed to the attached drawings, wherein like reference numerals or characters indicate corresponding or the like components. In the drawings:

FIG. 1 is a diagram useful in explaining the contemporary art;

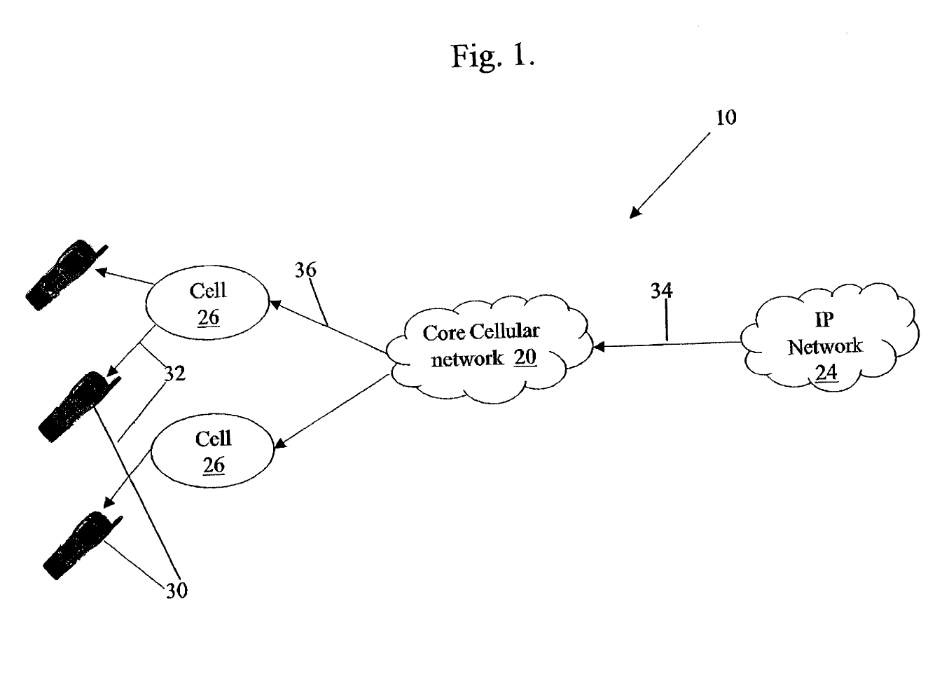

FIG. 2 is a diagram showing an embodiment of the present invention;

FIG. 3 is a flow diagram of a process in accordance with an embodiment of the present invention; and

FIG. 4 is a diagram showing an alternate embodiment of the present invention.

### DETAILED DESCRIPTION OF THE DRAWINGS

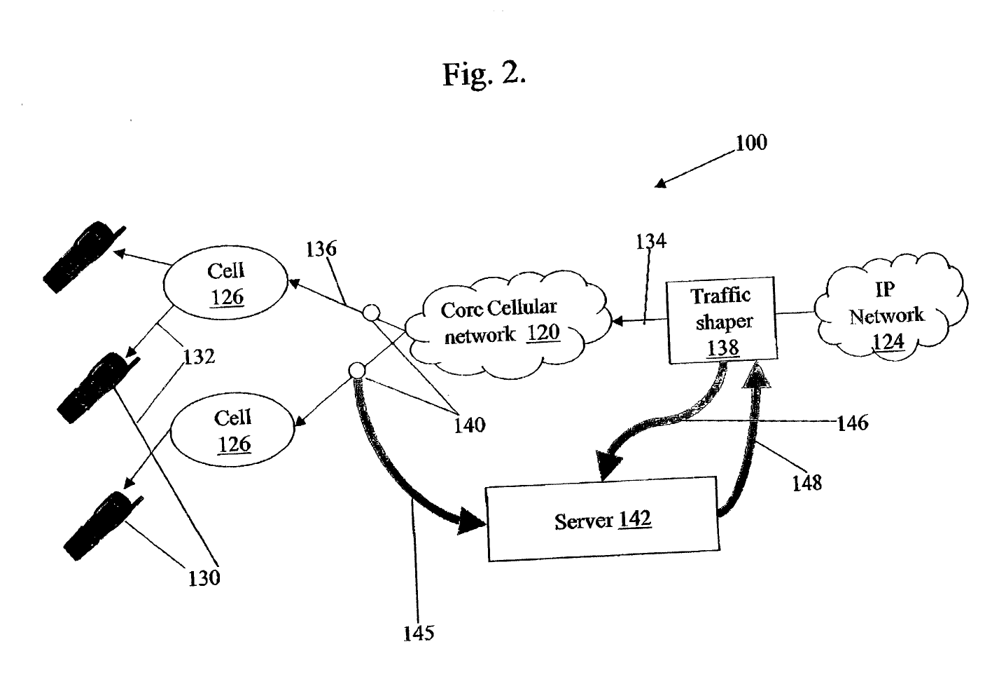

FIG. 2 shows an exemplary data network 100in accordance with an embodiment of the present invention. Here, a core cellular network 120 communicates with a packet data network, such as an Internet Protocol (IP) network 124 and at least one cell 126, (two cells 126 are shown for example purposes only), that provide services to subscribers 130 (three shown for example purposes only), typically over channels or data links 132, for example radio channels. The packet data network, here, for example, the IP network 124, connects with the core cellular network 120 over lines 134 or the like, and defines the “IP side” of the data network. The core cellular network 120 connects with the cells 126 (although two are shown, this is exemplary only) over lines 136 or the like, and defines the “cellular side” of the network. This core cellular network 120 can be formed from at least one of a server, a switch or a gateway, or any amount of these structures in any combination.

A resource management device, such as a traffic shaper 138, typically sits on or along the line 134, or anywhere the IP traffic can pass through it, on the IP side of the network 100, and a measuring unit(s) 140, for example a queuing device, typically sits on or along line 136, or anywhere the cellular traffic can pass through it, on the cellular side of the network 100. A server 142, typically including storage media, processors, and other related hardware and software, or alternately including software that utilizes an existing server within the network 100, on which processes in accordance with embodiments of the invention are preformed, sits intermediate the traffic shaper 138 and measuring unit 140. This server 142 is in communication with the traffic shaper 138 and the measuring unit 140, as represented by the arrows 145, 146, 148.

The server 142 monitors cellular traffic flow through line 136, typically at the measuring unit 140, to obtain data, typically measurements, concerning the available cell resources. The measuring unit 140 communicates measurements to the server 142, typically by sending signals or the like. These resources, typically bandwidth, on the cellular side of the network 100, are referred to as “cellular rate”. The measurements are communicated to the server as per the arrow 145 (shown to only one measuring device 140, for purposes of this example only).

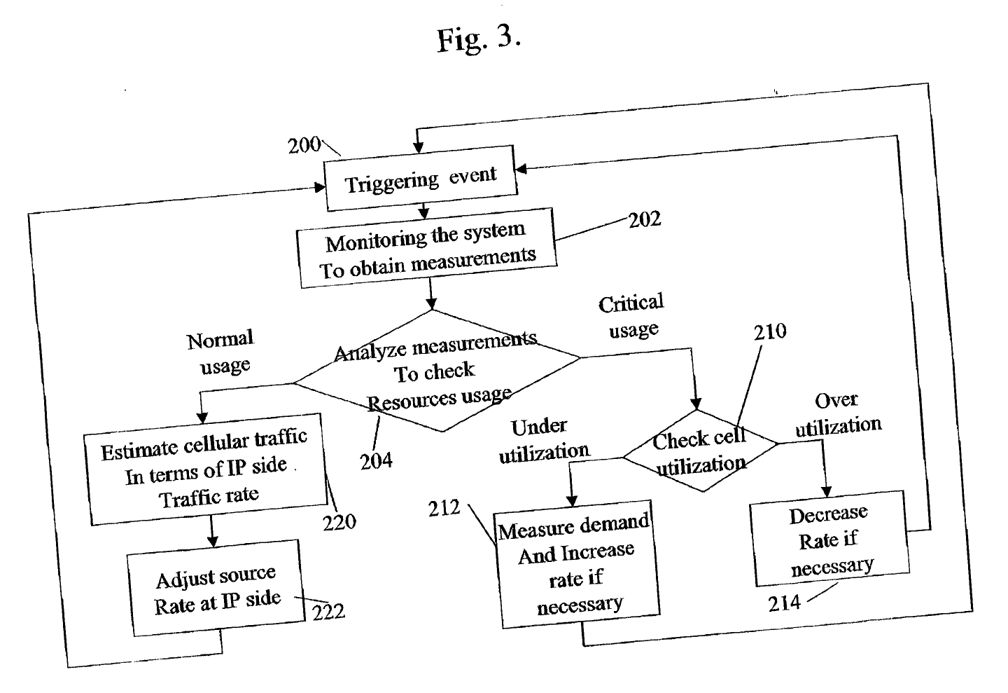

The server 142 monitors IP resources, typically IP traffic (traffic bandwidth), in particular that part of the IP traffic that is associated with the cellular traffic, that flows through line 134, typically at the traffic shaper 138. This monitoring is performed to obtain data, typically measurements concerning the IP traffic bandwidth. The bandwidth of the IP traffic, associated with the cellular traffic, on the IP side of the network 100, is referred to as “source rate”. The measurements are communicated to the server 142 as per arrow 146. The server 142 performs the process shown in FIG. 3 and detailed below, and controls the traffic shaper 138 (typically communicating with it by signals or the like), as per arrow 148.

In both cases above, the monitoring by the server 142 can be either active (typically by signaling the measuring devices 140and/or traffic shaper 138 to request measurements) or passive (typically by waiting for signaling from the measuring devices 140 and/or traffic shaper 138 followed by measurements). These measurements can be obtained actively or passively.

The traffic shaper 138 typically controls the cellular downlink traffic (from the IP side of the data network 100 to the subscribers 130 via their cellular devices, for example, cellular telephone, personal digital assistant (PDA), etc.) by policing or shaping the traffic, so as to restrict the bandwidth. This traffic shaper 138 typically controls the cellular uplink traffic from the subscribers 130 to the IP side of the network 100. This is typically accomplished by the traffic shaper blocking downlink messages, resulting in associated uplink sessions being dropped.

In an alternate embodiment of the network 100, the resource manager (here, the traffic shaper 138) and measuring unit(s) 140 and server 142 can be used for the purpose of monitoring the cell traffic in terms of IP traffic only, without any active management of the network 100.

FIG. 3 shows a process, in the form of a flow diagram, in accordance with an embodiment of the present invention. This process correlates measurements of traffic, or data corresponding thereto, on the IP and cellular sides of a data network. This correlation can be employed to manage traffic on the cellular side of the network from the IP side of the network. While a single cycle of operation is shown, the process may also be applied in multiple cycles.

For example, the process of FIG. 3 is described with respect to the data network 100 of FIG. 2, for purposes of explanation. However, the process of FIG. 3 is not limited to this data network 100, and can be preformed on multiple other suitable networks.

The process is an iterative process, typically performed on a per cell basis. It can be continuous over time. It is initiated by a triggering event, and can involve continuously monitoring the cell queuing device, typically by measurements of the queuing device queue size and output rate, analogous to “bucket size” and “leak-rate” respectively. In addition, the host network, or its attached source transmission device, is monitored for the rate of IP traffic associated with the cell, referred to hereafter as “source rate”. As a result of applying the process, continuous control over the source rate is applied, so that utilization of the cell's resources is optimized.

The process detailed below processes and analyzes the obtained or received measurements, or data corresponding thereto, in stages. At a first stage, analysis shows whether the cell or shared access media resources are within a range of normal usage, or whether resources usage has reached a critical value.

Upon conducting the first stage of analysis, a second stage of analysis is preformed, dependent on the results obtained by the first stage. If resource usage was determined to be within normal range, the measurements are correlated into an estimate of the cellular rate in terms of source rate. This estimate is preformed in an estimation process where transformation parameters are determined and applied to data corresponding to these measurements, to represent the cellular rate on the cellular side of the network 100 in terms of the source rate on the IP side of the network 100.

This estimation process results in an approximation of available bandwidth at the cell 126, in terms of source rate for the IP side of the network 100. This approximated available cell bandwidth may be used for performing resource allocation or bandwidth management by the traffic shaper 138 on the IP side of the network 100.

In case the results of the first stage of analysis indicate critical usage of the cell or resources, then further analysis is conducted in order to determine if these resources are under utilized or over utilized. According to this decision, a determination of the adjustment of source transmission rate is made, where this adjustment typically includes increasing or decreasing the transmission rate.

With the resources having been adjusted, the present iteration of the process or cycle of the process is now complete. The process resumes in a subsequent cycle, upon a new triggering event.

The process begins at block 200, upon a triggering event. This triggering event is typically generated, for example, by a periodic clock, arrival of a predetermined message(s), certain numbers of measurements, or other administrator set criteria (conditions).

At block 202 the network 100 is monitored to obtain measurements at various times during the monitoring. These measurements can be single or multiple values. Typical measured values include, current source rate, xₜ, taken from the IP side, typically by the traffic shaper 138, current bucket size, Bₜ, and current leak-rate Lₜ, both typically taken from the shared access media or cell 126, or its associated measuring device (queuing device) 140. While multiple measurements are preferred, as few as one measurement is sufficient. These measurements can be taken at any time, and for example may be taken contemporaneous with respect to each other.

Measurements are considered contemporaneous if the measurements of bucket size Bₜ and leak-rate Lₜ, as taken from the cellular side of the network 100, were conducted at approximately the same time with the measurement of source rate xₜ, taken from the IP side of network 100, up to a given tolerance. This tolerance can be defined as a certain portion of the time interval, for example, it can be fixed to 1 second of deviation between corresponding measurements. In case that a correlation of time does not exist, missing measurements may be interpolated, typically linearly or polynomially. Alternately, the server 142 can conduct measurements such that one side of the network 100, typically the IP side, is measured at a higher rate than the other (i.e., cellular side), allowing for correspondence of measurements from each side. This correspondence allows for synchronized measurements within the required timing tolerance.

At block 204 the measurements are analyzed, to determine the extent of bandwidth utilization. For example, this could be done by analyzing the value or values of bucket size.

If multiple values of bucket size have been measured these values can be 5statistically analyzed, and the median, Mₜ, for example, is obtained, among other values. This median Mₜ is then subject to a comparison, for example, in accordance with the following relation:

0.15·B_{M}<Mₜ<0.85·B_{M} (1)

where,

B_{M} is the pre-determined maximum utilization of the queuing device bucket.

In case Mₜ is outside the range specified by Relation (1), it is then determined that the resources of the cell or shared access media are in critical usage, whereupon further analysis of resources utilization is necessary. The process then moves to block 210.

If the median, Mₜ, is within the range specified by Relation (1), then it is determined that the usage of the cell or shared access media resources is within a normal range, whereupon further estimation of cellular traffic rate is required, and operation passes to block 220.

At block 210,an analysis is performed as to whether the cell or shared access media is over utilized or under utilized. For example, in this analysis, the median bucket size, Mₜ can be compared to the administrator's predetermined maximum utilization of the queuing device bucket, as expressed by the following relations:

Mₜ≦0.15·B_{M} (2)

Mₜ≧0.85·B_{M} (3)

In case the condition expressed in Relation (2) is met, cell resources are under utilized. Accordingly, the source rate should be increased. The process then moves to block 212.

Alternatively, if the condition expressed in Relation (3) is met, cell resources are over utilized. Accordingly, the source rate should be decreased. The process then moves to block 214.

At block 212, the traffic shaper 138 measures the demand for IP traffic associated with a cell 126. If there is an unsatisfied demand, and since the cell is under utilized, the source rate may be increased to accommodate this unsatisfied demand up to a maximum amount as set by the following formula:

Rₜ=1.35·R_{t 1} (4)

where,

Rₜ is the calculated source rate to enforce; and

Rₜ₋₁ is the previous source rate.

The process then returns to block 200.

At block 214, the cell is probably over utilized and congested, the source rate may be decreased, in order to optimize cell utilization and avoid congestion. This reduction may be done in accordance with the following formula:

Rₜ=0.75·Rₜ₋₁ (5)

The operation of block 214 ends as the new calculated source rate, Rₜ is enforced on the IP traffic associated with the cell (by the traffic shaper 138). The process then returns to block 200.

At block 220 the cellular rate, on the cellular side of the network 100, is estimated in terms of the source rate, on the IP side of the network 100.

This estimation is necessary to at least in part account for overhead. This overhead is due to the following. The IP traffic associated with the cell is encapsulated within multiple protocol levels, prior to transmission to the mobile subscribers thorough the cell. This encapsulation includes random overhead, dependent on packet sizes. Also, there is random traffic overhead in the cell, due to parasitic packets, unrelated to the IP traffic, and additional overhead may be due to retransmission of packets, which were lost (transmitted with errors), over the radio interfaces or data links.

The overhead is analyzed in two steps: 1. a preprocessing step involving determining the cell resources in terms of gross cellular rate, which is the queuing device input rate on the cellular side; and 2. an estimation step involving determining the estimator parameters. An exemplary process implementing these two steps is now detailed.

In the first (preprocessing) step, the gross cellular rate is determined, taking into account the measured leak-rate and bucket size. For example, this could be done by the formula:

$${y}_{t} = {L}_{t} + \frac{{B}_{t} - {B}_{t - 1}}{Δ t} \qquad ( 6 )$$

where,

yₜ is the gross cellular rate at time t;

Lₜ is the measured leak-rate at time t;

Bₜ is the measured leak-rate at time t;

Bₜ₋₁ is the measured leak-rate at time t−1; and

Δt is the length of the time interval between t and t−1.

Alternately, if the queuing devices provide the leak rate Lₜ, and the gross cellular rate yₜ, directly, then the bucket size Bₜ is calculated recursively from Equation (6) above, starting from the zero state.

The second (estimation) step applies multiple measurements of gross cellular rate and net cellular rate in an estimation process, for determining the estimator or transformation parameters. This estimation process requires assuming a model, which describes the gross cellular rate in terms of net cellular rate, and results in calculations of model parameters. These model parameters may be used later for transforming each measurement of gross cellular rate into terms of net cellular rate. This estimation process can utilize linear or non-linear methods, adaptive or static models, dynamic or fixed methods, stateless or stateful models, etc.

An example for this estimation model is a linear model, where initially, the gross cellular traffic is linearly approximated in relation to measured net source rate, as in the following Equation:

yₜ≈a+b·xₜ (7)

where,

a is a model parameter;

b is a model parameter; and

xₜ is the measured source rate, as measured, for example at measuring device 140 of FIG. 2.

Next, an estimation of a and b is derived by combining Equations (6) and (7) to minimize the distance, e.g., in a least squares sense, between the approximation of Equation (7) and the calculation of gross downlink traffic of Equation (6). For example, the distance is given by the formula:

$$Ψ ( a , b ) = {\sum }_{t ∈ {T}^{*}} {( a + b \cdot {x}_{t} - {y}_{t} )}^{2} \qquad ( 8 )$$

where,

T* is the set of measurements, previous and present, which should be used in the approximation. The number of previous measurements which should be taken into account can either be unlimited, or with a predefined limit. For example, the set T* might be limited to include only up to 10 previous measurements. Additional filtering conditions on this set might be applied, so that, for example, only measurements that are within a range are included. The range is in accordance with the following relation:

0.1·B_{M}<Bₜ<0.9·B_{M} (9)

where,

B_{M} is defined in Relation (1) above; and

Bₜ is defined in Equation (6) above.

An approximation of a and b, the model parameters for the model represented in Equation (7), is obtained by minimizing the distance function Ψ of Equation (8). This could be done, for example, by solving the system of equations given in the following formulas:

$$\begin{matrix}\frac{\partial Ψ}{\partial a} = 0 & ( 10 ) \\ \frac{\partial Ψ}{\partial b} = 0 & ( 11 )\end{matrix}$$

Solving Equations (10) and (11) yields the following formulas for the calculated values a and b:

$$b = \frac{{S}_{xy} - {S}_{x} \cdot {S}_{y}}{{S}_{{x}^{2}} - {S}_{x}^{2}} \qquad ( 12 )$$

a=S_{y}−b·Sₓ (13)

where,

Sₓ is the sum of the measurements xₜ taken over the set T*, defined in Equation (8). This sum could be over an exponentially decaying window, or a sliding window, as in the following formula:

$${S}_{x} = {\sum }_{t ∈ {T}^{*}} {x}_{t} \qquad ( 14 )$$

S_{y}, S_{xy} and Sₓ_{²} are sums of measurements and sums of products of measurements, that are typically sliding windows, but could also be exponentially decaying windows. Sliding windows, for example, are defined by the following formulae:

$$\begin{matrix}{S}_{y} = {\sum }_{t ∈ {T}^{*}} {y}_{t} & ( 15 ) \\ {S}_{xy} = {\sum }_{t ∈ {T}^{*}} {x}_{t} \cdot {y}_{t} & ( 16 ) \\ {S}_{{x}^{2}} = {\sum }_{t ∈ {T}^{*}} {x}_{t}^{2} & ( 17 )\end{matrix}$$

This determination of the model parameters, a and b, ends the operation of block 220. The process then moves to block 222.

At block 222, the source rate is adjusted in accordance with the cell capacity. The cell capacity is the maximum bandwidth of packet data traffic above which the cell becomes congested. This capacity can be represented in terms of either cellular rate or source rate.

Having calculated the model parameters a and b (of block 220), the cellular rate measurements are then calculated, with cell capacity extracted from these calculations.

The cell capacity extraction process includes two steps. Filst, the raw capacity is calculated. This raw capacity is the leak-rate, under the condition that continuous traffic is flowing through the bucket, with the bucket not overflowing, as detailed below. Second, the cell capacity measurements are then taken from the raw cell capacity calculations, typically by filtering. The filtering may be done prior to or following the representation of the raw cell capacity in source rate terms.

The raw capacity measurements are defined to be, for example, the set of bak rate measurements Lₜ, where the bucket size Bₜ is above some threshold, such that the cell capacity is utilized by the flowing traffic. For example, the set of raw capacity measurements could be defined by:

{Lₜ:tεT*} (18)

where,

T* is the set defined by Formula (9).

The raw capacity is now represented in terms of source rate Rₜ, for each available time tεT*, according to the following formula:

$${R}_{t} = \frac{{L}_{t} - a}{b} \qquad ( 19 )$$

Second, the cell capacity, in terms of source rate, is extracted by applying filtering or smoothing. Here, the filtering is applied following the representation of the raw cell capacity in terms of source rate. Alternately, the filtering may be performed on the raw cell capacity in terms of cellular rate. Some suitable filters may be a sliding window averaging filter over time, a weighted geometric filter over time, a median filter over time, etc. may be used.

Following this last step, the cell capacity calculations may be used for resource management, including traffic shaping. This is typically preformed as the server 142 passes signals corresponding to the cell capacity, to the traffic shaper 138. The traffic shaper 138 utilizes these signals to perform resource management, including making bandwidth adjustments of the IP traffic, on the line 134, or any other location where IP traffic flows. The process then returns to block 200.

In returning to block 200, either from block 212, block 214 or block 222, a cycle is complete. During this cycle, available cell bandwidth has been computed dynamically in an automatic manner and “on the fly”. The computation preformed is in terms of source rate, and was applied for dynamically adjusting source rate. Subsequent cycle(s) may be performed as necessary or desired (upon returning to block 200).

The process detailed above, all or portions thereof, can be embodied in programmable storage devices readable by a machine or the like, or other computer-usable storage medium, including magnetic, optical or semiconductor storage, or other source of electronic signals.

In another alternate embodiment, similar to that of FIG. 2, as shown and described above, measuring devices, 140, can be configured such that they supply cell capacity measurements, in terms of cellular rates. These cell capacity measurements may be used together with the rate measurements, and estimation methods as described above, to calculate the cell capacity in terms of source rate. The cell capacity, in terms of source rate, may then be applied for resource management, such as traffic shaping, typically on the IP side of the network 100 as detailed above.

In still another alternate embodiment, similar to that of FIG. 2, as shown and described above, measuring devices, 140, can be configured for individual subscribers 130. These per subscriber measuring devices can be constructed and arranged to supply measurements of leak-rate and bucket size for each individual subscriber, or each individual element within the cell. Here, measurements of leak-rate and source rate are correlated as detailed above, in order to calculate the leak-rate in source rate terms for each individual subscriber 130. These calculations may be used for purposes of resource management, including traffic shaping, on the IP side of the network 100.

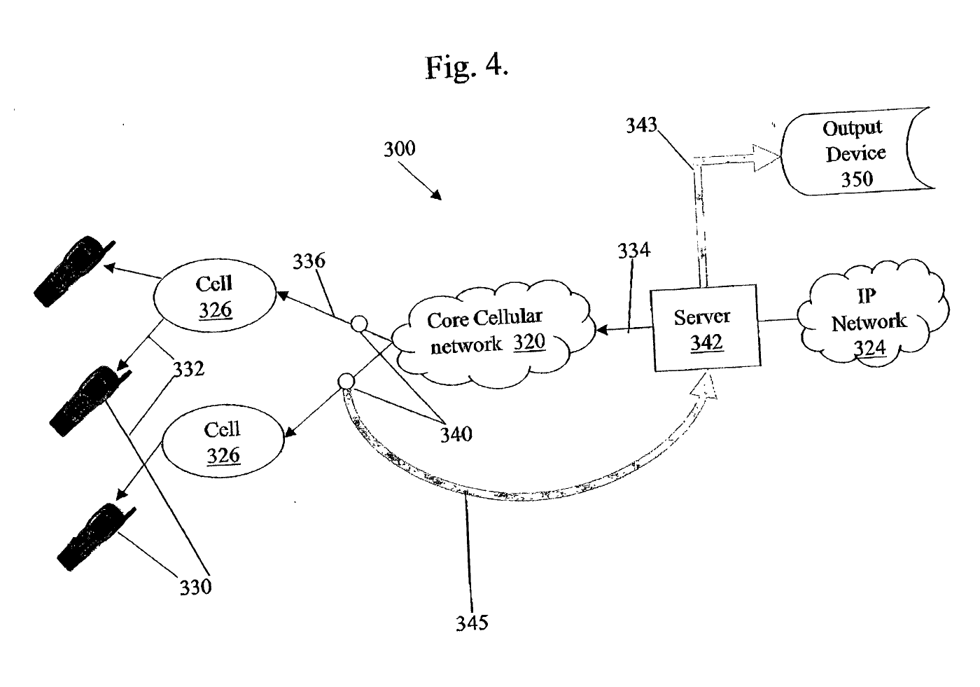

FIG. 4 shows an exemplary data network 300 in accordance with another embodiment of the present invention. The data network 300 is similar to data network 100, except where indicated. Similarities are indicated with component numbering that has been incremented by 200, such that similar components correspond in the “100” and “300” series.

Here, a core cellular network 320 communicates with an Internet Protocol (IP) network 324 and cells 326 (two shown for example purposes only), that provide services to subscribers 330 (three shown for example purposes only), typically over channels or data links 332. The IP network 324 connects with the core cellular network 320 over lines 334 or the like, and defines the “IP side” of the data network 300. The core cellular network 320 connects with the cells 326 (although two are shown, this is exemplary only) over lines 336 or the like, and defines the “cellular side” of the network.

Measuring units 340, for example, queuing devices, sit on lines 336, on the cellular side of the network 300. A server 342 performs processes in accordance with embodiments of the invention. The server 342 sits on or along line 334, intermedate the IP network 324 and core cellular network 320, on the IP side of the network 300. Server 342 is in communication with both the measuring device 340, as represented by the arrow 345 (shown to only one measuring device 340, for purposes of this example only), and with output device 350, as represented by arrow 343. The output device 350 can be a disk, magnetic or otherwise, a monitor, a printer, a scope, or the like.

The server 342 monitors the line 336, typically at the measuring unit 340, to obtain data concerning the available cell resources. The server 342 also monitors line 334, on which it sits, to obtain data, typically taking measurements concerning the source rate. The server 342 in turn either controls the source rate on line 334, in accordance with the process detailed above, or delivers source rate results to the output device 350, where both these actions can be taken contemporaneously and in some cases simultaneously.

The methods and apparatus disclosed herein have been described with exemplary reference to specific hardware and/or software. The methods have been described as exemplary, whereby specific steps and their order can be omitted and/or changed by persons of ordinary skill in the art to reduce embodiments of the present invention to practice without undue experimentation. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for managing at least one resource in a data network, said data network including first and second sides in communication with each other, said first side including at least an Internet Protocol Network and said second side including at least one cell, said method comprising:
receiving data corresponding to at least one measurement of said at least one resource at each of said first and second sides;
analyzing said data corresponding to said at least one measurement at each of said first and second sides; and
controlling said at least one resource to said at least one cell, from said first side of said network.

2. The method of claim 1, additionally comprising signaling at least one device on said first side of said network to monitor said network on said first side.

3. The method of claim 1, additionally comprising signaling at least one device on said second side of said network to monitor said network on said second side.

4. The method of claim 2, wherein said at least one device on said first side includes a traffic shaper.

5. The method of claim 3, wherein said at least one device on said second side includes a measuring device.

6. The method of claim 5, wherein said measuring device includes at least one queuing device.

7. The method of claim 1, wherein said at least one measurement at said first side is in terms of source rate and said at least one measurement at said second side is in terms of cellular rate.

8. The method of claim 7, wherein said analyzing includes correlating said measurements into an estimate of the cellular rate in terms of source rate.

9. The method of claim 8, wherein said correlating includes determining transformation parameters and applying said transformation parameters to said measurements to represent said cellular rate on said second side of said network in terms of said source rate on said first side of said network.

10. The method of claim 1, wherein said controlling said at least one resource to said at least one cell, from said first side of said network, includes signaling at least one device on said first side of said network to allocate said at least one resource on said first side of said network.

11. The method of claim 10, wherein said at least one device on said first side of said network includes a traffic shaper.

12. The method of claim 1, wherein said at least one resource includes bandwidth.

13. A method for managing at least one resource in a data network, said data network including first and second sides in communication with each other, said first side including at least an Internet Protocol Network and said second side including at least one cell, said method comprising:
obtaining at least one measurement of said at least one resource at each of said first and second sides;
analyzing said at least one measurement from each of said first and second sides; and
controlling said at least one resource to said at least one cell, from said first side of said network.

14. The method of claim 13, additionally comprising, monitoring said network on each of said respective first and second sides.

15. The method of claim 13, wherein said at least one measurement at said first side is in terms of source rate and said at least one measurement at said second side is in terms of cellular rate.

16. The method of claim 15, wherein said analyzing includes correlating said measurements into an estimate of the cellular rate in terms of source rate.

17. The method of claim 16, wherein said correlating includes determining transformation parameters and applying said transformation parameters to said measurements to represent said cellular rate on said second side of said network in terms of said source rate on said first side of said network.

18. The method of claim 13, wherein said controlling said at least one resource to said at least one cell, from said first side of said network, includes allocating said at least one resource on said first side of said network.

19. The method of claim 13, wherein said at least one resource includes bandwidth.

20. A method for estimating capacity of at least one cell comprising:
a. monitoring traffic associated with said at least one cell through at least one queuing device, said queuing device including a queue;
b. obtaining at least one measurement of the output rate from said queue;
c. obtaining at least one measurement of the amount of data in said queue; and
d. determining at least one capacity estimation as an output rate from said queue, provided that said amount of data is within predetermined limits.

21. The method of claim 20, wherein said steps (b) and (c) are preformed contemporaneously.

22. The method of claim 21, wherein said steps (b) and (c) are performed simultaneously.

23. The method of claim 20, wherein said at least one capacity estimation includes a plurality of capacity estimations and additionally comprising, filtering said plurality of capacity estimations.

24. An apparatus for managing at least one resource in a data network, said data network including first and second sides in communication with each other, said first side including at least an Internet Protocol Network and said second side including at least one cell, said apparatus comprising:
a storage device; and
a processor programmed to:
receive data corresponding to at least one measurement of said at least one resource at each of said first and second sides;
analyze said data corresponding to said at least one measurement at each of said first and second sides; and
control said at least one resource to said at least one cell, from said first side of said network.

25. The apparatus of claim 24, wherein said processor is additionally programmed to:
signal at least one device on said first side of said network to monitor said network on said first side.

26. The apparatus of claim 24, wherein said processor is additionally programmed to:
signal at least one device on said second side of said network to monitor said network on said second side.

27. The apparatus of claim 24, wherein said processor is additionally programmed to:
utilize said at least one measurement at said first side in terms of source rate and said at least one measurement at said second side in terms of cellular rate.

28. The apparatus of claim 27, wherein said processor is additionally programmed to:
analyze said data by at least correlating said measurements into an estimate of the cellular rate in terms of source rate.

29. The apparatus of claim 28, wherein said correlating includes determining transformation parameters and applying said transformation parameters to said measurements to represent said cellular rate on said second side of said network in terms of said source rate on said first side of said network.

30. The apparatus of claim 24, wherein said processor is additionally programmed to:
control said at least one resource to said at least one cell, from said first side of said network by steps including, signaling at least one device on said first side of said network to allocate said at least one resource on said first side of said network.

31. The apparatus of claim 30, wherein said at least one device on said first side of said network includes a traffic shaper.

32. The apparatus of claim 24, wherein said at least one resource includes bandwidth.

33. A programmable storage device readable by a machine, tangibly embodying a program of instructions executable by a machine to perform method steps for managing at least one resource in a data network, said data network including first and second sides in communication with each other, said first side including at least an Internet Protocol Network and said second side including at least one cell, said method steps selectively executed during the time when said program of instructions is executed on said machine, comprising:
receiving data corresponding to at least one measurement of said at least one resource at each of said first and second sides;
analyzing said data corresponding to said at least one measurement at each of said first and second sides; and
controlling said at least one resource to said at least one cell, from said first side of said network.

34. An apparatus for estimating capacity of at least one cell comprising:
a storage device; and
a processor programmed to:
a. monitor traffic associated with said at least one cell through at least one queuing device, said queuing device including a queue;
b. obtain at least one measurement of the output rate from said queue;
c. obtain at least one measurement of the amount of data in said queue; and
d. determine at least one capacity estimation as an output rate from said queue, provided that said amount of data is within predetermined limits.

35. The apparatus of claim 34, wherein said processor is additionally programmed to perform said steps (b) and (c) contemporaneously.

36. The apparatus of claim 35, wherein said processor is additionally programmed to perform said steps (b) and (c) simultaneously.

37. A programmable storage device readable by a machine, tangibly embodying a program of instructions executable by a machine to perform method steps for estimating capacity of at least one cell, said method steps selectively executed during the time when said program of instructions is executed on said machine, comprising:
monitoring traffic associated with said at least one cell through at least one queuing device, said queuing device including a queue;
obtaining at least one measurement of the output rate from said queue;
obtaining at least one measurement of the amount of data in said queue; and
determining at least one capacity estimation as an output rate from said queue, provided that said amount of data is within predetermined limits.
